(19) United States
(12) Patent Application Publication
(10) Pub. No.: US 2011/0051895 A1
(43) Pub. Date: Mar. 3, 2011

(54) X-RAY SYSTEM WITH EFFICIENT ANODE HEAT DISSIPATION

(75) Inventors: Gereon Vogtmeier, Aachen (DE); Rainer Pietig, Herzogenrath (DE); Astrid Lewalter, Aachen (DE); Rolf Karl Otto Behling, Norderstedt (DE)

(73) Assignee: Koninklijke Philips Electronics N.V.

(21) Appl. No.: 12/990,814

(22) PCT Filed: May 4, 2009
(86) PCT No.: PCT/IB09/51814

§ 371 Date: Nov. 3, 2010

(30) Foreign Application Priority Data
May 9, 2008 (EP) 08103899.4

(51) Int. Cl. H05G 1/70; H01J 35/24; B82Y 99/00

(52) U.S. Cl. 378/92; 378/125; 378/136; 977/949

(57) ABSTRACT

X-ray systems for use in high-resolution imaging applications with an improved power rating are provided. An X-ray source comprises at least one integrated actuator unit (206, 206′, 206a or 206b) for performing at least one translational and/or rotational displacement by moving the position of the X-ray source's anode (204, 204′, 204a′ or 204b′) relative to a stationary reference position. This helps to overcome power limitations due to an overheating of the anode at its focal ̂spot position (205). In addition to that, a focusing unit (203) for allowing an adapted focusing of the anode's focal spot (205) which compensates deviations in the focal spot size resulting from said anode displacements and/or a deflection means (211, 21 Ia or 21 Ib) for generating an electric and/or magnetic field deflecting the electron beam (202, 202a or 202b) in a direction opposite to the direction of the rotary anode's displacement movement may be provided.

The present invention refers to X-ray systems for use in high-resolution imaging applications with an improved power rating and, more particularly, to a variety of system configurations for an X-ray based image acquisition system using an X-ray source of the rotary anode type or, alternatively, an array of spatially distributed X-ray sources fabricated in carbon nanotube (CNT) technology, thus allowing higher sampling rates for an improved temporal resolution of acquired CT images as needed for an exact reconstruction of fast moving objects (such as e.g. the myocard) from a set of acquired 2D projection data. According to the present invention, each X-ray source comprises at least one integrated actuator unit for performing at least one translational and/or rotational displacement by moving the position of the X-ray source's anode relative to a stationary reference position, wherein the latter may e.g. be given by a mounting plate or an electron beam emitting cathode which provides an electron beam impinging on said anode. In addition to that, a focusing unit for allowing an adapted focusing of the anode's focal spot which compensates deviations in the focal spot size resulting from said anode displacements and/or a deflection means for generating an electric and/or magnetic field deflecting the electron beam in a direction opposite to the direction of the rotary anode's displacement movement may be provided.

### BACKGROUND OF THE INVENTION

Conventional high power X-ray tubes typically comprise an evacuated chamber which holds a cathode filament through which a heating or filament current is passed. A high voltage potential, usually in the order between 40 kV and 160 kV, is applied between the cathode and an anode which is also located within the evacuated chamber. This voltage potential causes a tube current or beam of electrons to flow from the cathode to the anode through the evacuated region in the interior of the evacuated chamber. The electron beam then impinges on a small area or focal spot of the anode with sufficient energy to generate X-rays.

Today, one of the most important power limiting factor of high power X-ray sources is the melting temperature of their anode material. At the same time, a small focal spot is required for high spatial resolution of the imaging system, which leads to very high energy densities at the focal spot. Unfortunately, most of the power which is applied to such an X-ray source is converted into heat. Conversion efficiency from electron beam power to X-ray power is at maximum between about 1% and 2%, but in many cases even lower. Consequently, the anode of a high power X-ray source carries an extreme heat load, especially within the focus (an area in the range of about a few square millimeters), which would lead to the destruction of the tube if no special measures of heat management are taken. Efficient heat dissipation thus represents one of the greatest challenges faced in the development of current high power X-ray sources. Commonly used thermal management techniques for X-ray anodes include:
using materials that are able to resist very high temperatures,
using materials that are able to store a large amount of heat, as it is difficult to transport the heat out of the vacuum tube,
enlarging the thermally effective focal spot area without enlarging the optical focus by using a small angle of the anode, and
enlarging the thermally effective focal spot area by rotating the anode.

Except for high power X-ray sources with a large cooling capacity, using X-ray sources with a moving target (e.g. a rotating anode) is very effective. Compared to stationary anodes, X-ray sources of the rotary-anode type offer the advantage of quickly distributing the thermal energy that is generated in the focal spot such that damaging of the anode material (e.g. melting or cracking) is avoided. This permits an increase in power for short scan times which, due to wider detector coverage, went down in modem CT systems from typically 30 seconds to 3 seconds. The higher the velocity of the focal track with respect to the electron beam, the shorter the time during which the electron beam deposits its power into the same small volume of material and thus the lower the resulting peak temperature.

High focal track velocity is accomplished by designing the anode as a rotating disk with a large radius (e.g. 10 cm) and rotating this disk at a high frequency (e.g. more than 150 Hz). However, as the anode is now rotating in a vacuum, the transfer of thermal energy to the outside of the tube envelope depends largely on radiation, which is not as effective as the liquid cooling used in stationary anodes. Rotating anodes are thus designed for high heat storage capacity and for good radiation exchange between anode and tube envelope. Another difficulty associated with rotary anodes is the operation of a bearing system under vacuum and the protection of this system against the destructive forces of the anode's high temperatures. In the early days of rotary anode X-ray sources, limited heat storage capacity of the anode was the main hindrance to high tube performance. This has changed with the introduction of new technologies. For example, graphite blocks brazed to the anode may be foreseen which dramatically increase heat storage capacity and heat dissipation, liquid anode bearing systems (sliding bearings) may provide heat conductivity to a surrounding cooling oil, and providing rotating envelope tubes allows direct liquid cooling for the backside of the rotary anode.

If X-ray imaging systems are used to depict moving objects, high-speed image generation is typically required so as to avoid occurrence of motion artefacts. An example would be a CT scan of the human heart (cardiac CT): In this case, it would be desirable to perform a full CT scan of the myocard with high resolution and high coverage within less than 100 ms, this is, within the time span during a heart cycle while the myocard is at rest. High-speed image generation, however, requires high peak power performance of the respective X-ray source.

Recent development of carbon nanotube technology based X-ray microsources nowadays enables X-ray system concepts with stationary, spatially distributed X-ray sources. CNT technology thereby implies the advantage of having X-ray sources with high spatial resolution and fast switching capability, which could thus lead to a new generation of CT scanner configurations with stationary instead of rotational X-ray sources. However, a limiting factor for the image quality of a concept with spatially distributed X-ray sources is the minimum pitch of the sources that also defines the maximum image acquisition frequency as given by the switching frequency of the particular X-ray sources in a fixed CT or micro-CT setup.

### SUMMARY OF THE INVENTION

Talking about CNT-based X-ray sources always indicates miniaturization as the size of the electron beam emitter and the anode would have to be in the range of few millimeters. But even a miniaturized X-ray source would face the thermal problem mentioned above. Providing a rotating anode would be an option also for the CNT X-ray source, but of course if we think about systems with distributed miniaturized X-ray sources and numbers of hundreds or even thousands of X-ray sources then the effort to implement a micro-rotation anode in each source would be relatively high. Aside therefrom, the reliability could be an issue as micro-vacuum systems with motors are not easy to realize (even though being possible and also an alternative). A more simple approach would be a small movement of the anode material such that the focal spot describes a relative motion on the anode in order to quickly distribute the heat dissipated in the focal spot by radiating different areas of the anode.

It may thus be an object of the present invention to provide a novel X-ray tube setup which overcomes the problems mentioned above.

In view of this object, a first exemplary embodiment of the present invention is directed to an X-ray scanner system comprising an array of spatially distributed, sequentially switchable X-ray sources, said X-ray sources being addressed by a programmable switching sequence with a given switching frequency, wherein each X-ray source comprises an anode with a planar X-radiation emitting surface inclined by an acute angle with respect to a plane normal to the direction of an incoming electron beam impinging on said anode at the position of a focal spot and at least one integrated actuator unit for performing at least one translational and/or rotational displacement movement of the anode relative to at least one stationary electron beam emitting cathode used for generating said electron beam. Thereby, said at least one integrated actuator unit may e.g. be given by a piezo crystal actuator which generates a mechanical stress or strain when an electric field is applied to it and thus moves the anode in a certain direction. As an alternative thereto, any other types of actuators can also be applied, of course, such as e.g. mechanical, motor-driven, electrostatic, magnetic, hydraulic or pneumatic actuators. In this way, the heated area is increased and a higher X-ray power at the output of the X-ray sources is possible.

According to the present invention, an actuator control unit may be foreseen which controls the size, direction, speed and/or acceleration of the anode's translational and/or rotational displacement movement performed by the at least one integrated actuator unit dependent on the deviation of the anode temperature at the focal spot position from a nominal operation temperature. This actuator control unit may thereby be adapted for controlling the size, direction, speed and/or acceleration of the anode's translational and/or rotational displacement movement performed by the at least one integrated actuator unit dependent on the switching frequency for sequentially switching said X-ray sources such that an image acquisition procedure executed by means of said X-ray scanner system yields a set of 2D projection images which allows an exact 3D reconstruction of an image volume of interest without blurring or temporal aliasing artifacts.

In addition to that, each X-ray source may comprise at least one focusing unit for focusing the electron beam on the position of the focal spot on the X-radiation emitting surface of said X-ray source's anode as well as a focusing control unit for adjusting the focusing of the anode's focal spot such that deviations in the focal spot size resulting from the translational and/or rotational displacement of the anode relative to the at least one stationary electron beam emitting cathode are compensated.

According to this embodiment, it may preferably be foreseen that the anode's translational displacement movement goes along a rectilinear displacement line in the direction of the anode's inclination angle, and the size of the anode's translational and/or rotational displacement movement may be in the range of the focal spot size or larger.

It may especially be provided that the X-ray beam emitted by the anode leads to the same X-ray beam direction and thus to the same field of view irrespective of the anode's inclination angle and irrespective of said displacement movement.

The spatially distributed X-ray sources may be given by a number of individually addressable X-ray microsources using field emission cathodes in the form of carbon nanotubes, and the at least one stationary electron beam emitting cathode may also be realized in carbon nanotube technology.

A further exemplary embodiment of the present invention refers to an X-ray scanner system comprising at least one X-ray source of the rotary anode type with an essentially disk-shaped rotary anode, wherein the rotary anode of the at least one X-ray source has a planar X-radiation emitting surface inclined by an acute angle with respect to a plane normal to the direction of an incoming electron beam impinging on said anode at the position of a focal spot. The proposed X-ray scanner system thereby comprises at least one integrated actuator unit for performing at least one translational displacement movement of said at least one X-ray source's rotary anode relative to a stationary mounting plate and an actuator control unit for controlling the size, direction, speed and/or acceleration of the rotary anode's translational displacement movement performed by the at least one integrated actuator unit dependent on the deviation of the anode temperature at the focal spot position from a nominal operation temperature. Furthermore, at least one deflection means for generating an electric and/or magnetic field deflecting the electron beam in a direction opposite to the direction of the rotary anode's translational displacement movement may be provided as well as a deflection control unit for adjusting the strength of the electric and/or magnetic field such that deviations in the focal spot position resulting from the translational displacement of the rotary anode relative to the stationary mounting plate are compensated.

By moving the focal spot outwards while moving the whole X-ray source in a compensating manner in order to keep the position of the X-ray beam constant in relation to the gantry and the detector, the heat capacity of the X-ray source can be increased. Electron beam deflection thereby enlarges the volume of heat spread of the focal spot track and improves the instantaneously available heat capacity.

According to this embodiment, the at least one integrated actuator unit may be given by an electromotor or by a piezo crystal actuator which generates a mechanical stress or strain when an electric field is applied to it.

Furthermore, it may preferably be foreseen that the anode's translational displacement movement goes along a rectilinear displacement line in the direction of the anode's inclination angle.

A still further exemplary embodiment of the present invention is directed to an X-ray scanner system which comprises two or more X-ray sources of the rotary anode type with each X-ray source having an essentially disk-shaped rotary anode, wherein each of these rotary anodes has a planar X-radiation emitting surface inclined by an acute angle with respect to a plane normal to the direction of an incoming electron beam impinging on the respective anode at the position of a focal spot. The X-ray scanner system thereby comprises at least one integrated actuator unit for performing at least one translational displacement movement of each rotary anode relative to a stationary mounting plate for generating said electron beam and at least one further integrated actuator unit for performing at least one translational displacement movement in the positions of the two or more X-ray sources' focal spots relative to each other. In addition to that, at least one deflection means for generating an electric and/or magnetic field deflecting the electron beam in a direction opposite to the direction of the rotary anode's translational displacement movement may be provided as well as a deflection control unit for adjusting the strength of the electric and/or magnetic field such that deviations in the focal spot position of the respective X-ray source relative to an X-ray detector irradiated by the X-radiation emitted from said X-ray source's rotary anode, said deviations resulting from the translational displacement of the rotary anode relative to the stationary mounting plate, are compensated.

In other words, it may be foreseen to increase the heat capacity of an X-ray source by moving its focal spot outwards while simultaneously moving the whole tube in a compensating manner in order to keep the position of the X-ray beam constant in relation to the X-ray scanner system's gantry and the particular detector attached to said gantry. The movement of the electron beam enlarges the volume of heat spread of the focal spot track and thus improves the instantaneously available heat capacity.

According to a further aspect of this embodiment, an actuator control unit may be foreseen for controlling the size, direction, speed and/or acceleration of the respective anode's translational displacement movement performed by the at least one integrated actuator unit dependent on the deviation of the anode temperature at the focal spot position from a nominal operation temperature. In addition to that, the actuator control unit may also be adapted for controlling the size and/or direction of the translational displacement movement in the positions of the two or more X-ray sources' focal spots relative to each other depending on the size of a region of interest to be scanned.

In this connection, it may preferably be foreseen that the rotary anode's translational displacement movement goes along a rectilinear displacement line in the direction of the anode's inclination angle. The translational displacement movement for adjusting the focal spot positions of the particular X-ray sources with respect to each other may go along a rectilinear displacement line in axial and/or radial direction relative to the rotor of a rotational gantry said X-ray scanner system is equipped with.

According to a further aspect of this embodiment, it may be provided that said X-ray sources are located in a single vacuum casing consisting of two parts connected by a bellows systems which allows for an adjustment of the focal spot positions in tangential and radial direction relative to the rotor of the rotational gantry. The X-ray source which is the most proximal with respect to a common electron beam emitting cathode shared by these X-ray sources may thereby have a bladed anode of the windmill type.

### BRIEF DESCRIPTION OF THE DRAWINGS

These and other advantageous aspects of the invention will be elucidated by way of example with respect to the embodiments described hereinafter and with respect to the accompanying drawings. Therein,

FIG. 1a shows a configuration of a conventional CT scanner apparatus as known from the prior art,

FIG. 1b shows a schematic block diagram of the CT scanner apparatus illustrated in FIG. 1a,

FIG. 2a shows a novel setting for an X-ray source according to a first exemplary embodiment of the present invention with an electron beam emitter of the carbon nanotube (CNT) type which generates an electron beam impinging on the position of a focal spot located on a surface of an X-radiation emitting anode inclined with respect to a plane normal to the direction of the electron beam, wherein said anode is translationally displaced in the direction of said electron beam by means of two stationarily mounted piezo actuators,

FIG. 2b shows a modification of the setting as depicted in FIG. 2a, wherein said anode is both translationally displaced in the direction of said electron beam and rotationally displaced about the focal spot position by means of the aforementioned two stationarily mounted piezo actuators which are individually controlled,

FIG. 3a shows a further novel setting for an X-ray source according to a second exemplary embodiment of the present invention with an electron beam emitter of the carbon nanotube (CNT) type which generates an electron beam impinging on the position of a focal spot located on a surface of an X-radiation emitting anode inclined with respect to a plane normal to the direction of the electron beam, wherein said anode is translationally displaced in the direction along the inclination angle of its inclined surface by means of a stationarily mounted piezo actuator,

FIG. 3b shows a modification of the setting as depicted in FIG. 3a, wherein said anode is both translationally displaced in the direction of said electron beam and rotationally displaced about the focal spot position by means of two stationarily mounted piezo actuators which are individually controlled,

FIG. 4 shows a design cross section (profile) of a conventional rotary anode disk as known from the prior art,

FIG. 5a shows a cross-sectional view of an X-ray tube of the rotary anode type according to a third exemplary embodiment of the present invention with an X-radiation emitting anode having a surface inclined with respect to a plane normal to the direction of a cathode's emitted electron beam impinging on the position of a focal spot located on said surface according to an exemplary embodiment of the present invention, said X-ray tube being equipped with an actuator unit for performing at least one translational displacement movement of said at least one X-ray source's rotary anode in the direction along the inclination angle of its inclined surface relative to a stationary mounting plate and with a deflection means for generating an electric and/or magnetic field deflecting said electron beam in a direction opposite to the direction of the rotary anode's translational displacement movement,

FIG. 5b shows a modification of the X-ray tube depicted in FIG. 5a with a further actuator unit for performing at least one translational displacement movement of said at least one X-ray source's rotary anode in a direction parallel to the anode's rotary shaft relative to said stationary mounting plate,

FIGS. 6a+b show two schematically depicted application scenarios with two X-ray tubes of the rotary anode type having a variable focal spot distance, wherein said focal spot distance is adjusted depending on the size of a region of interest to be scanned,

FIG. 7a shows an application scenario with two X-ray tubes of the rotary anode type each having an X-radiation emitting anode with a surface inclined with respect to a plane normal to the direction of an electron beam impinging on the position of a focal spot located on said surface according to an exemplary embodiment of the present invention, said X-ray tubes each being equipped with two actuator means for performing a translational displacement of their focal spots in a direction parallel to the anodes' rotary shafts relative to at least one stationary mounting plate and each being equipped with a deflection means for generating an electric and/or magnetic field deflecting the emitted electron beams such that the rotary anodes' translational displacement movement is compensated,

FIG. 7b shows an application scenario as depicted in FIG. 7a for the case of a wider region of interest,

FIG. 8a shows an application scenario with two X-ray tubes of the rotary anode type each having an X-radiation emitting anode with a surface inclined with respect to a plane normal to the direction of an electron beam impinging on the position of a focal spot located on said surface according to an exemplary embodiment of the present invention for the case of the inner part of the focal track being heated, said X-ray tubes each being equipped with two actuator means for performing a translational displacement of their focal spots in the direction along the inclination angles of their inclined surfaces relative to at least one stationary mounting plate and each being equipped with a deflection means for generating an electric and/or magnetic field deflecting the emitted electron beams in an opposite direction such that the anodes' translational displacement movement is compensated,

FIG. 8b shows an application scenario as depicted in FIG. 8a for the case of the outer part of the focal track being heated.

### DETAILED DESCRIPTION OF THE PRESENT INVENTION

In the following, the X-ray scanner system according to an exemplary embodiment of the present invention will be explained in more detail with respect to special refinements and referring to the accompanying drawings.

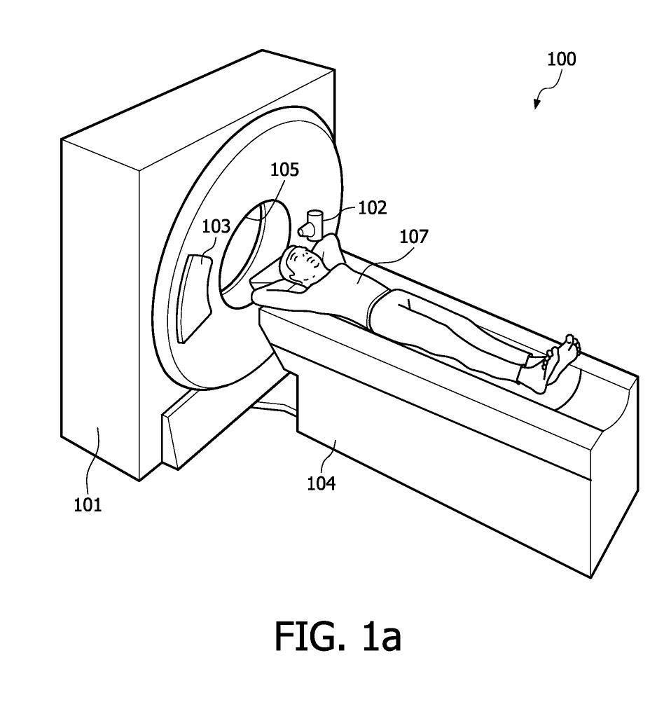

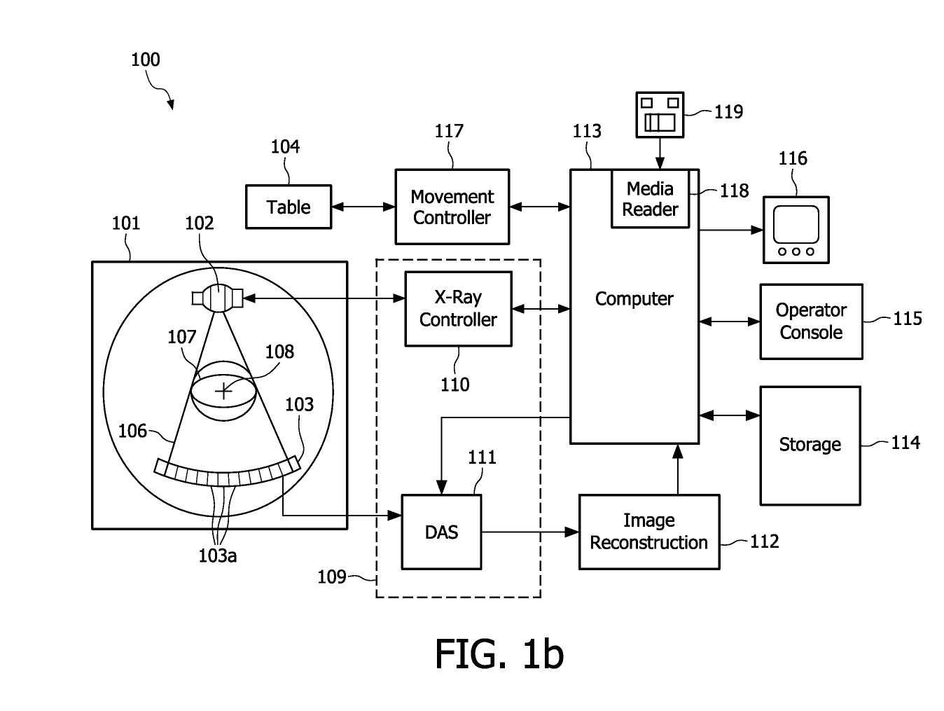

FIG. 1a shows a configuration of a CT imaging system as known from the prior art. In current CT imaging systems such as depicted in FIG. 1a, an X-ray source 102 mounted on a rotational gantry 101 rotates about the longitudinal axis 108 of a patient's body 107 or any other object to be examined while generating a fan or cone beam of X-rays 106. An X-ray detector array 103, which is usually mounted diametrically opposite to the location of said X-ray source 102 on said gantry 101, rotates in the same direction about the patient's longitudinal axis 108 while converting detected X-rays, which have been attenuated by passing the patient's body 107, into electrical signals. An image rendering and reconstruction system 112 running on a computer or workstation 113 then reconstructs a planar reformat image, a surface-shaded display or a volume-rendered image of the patient's interior from a voxelized volume dataset.

In the schematic block diagram as depicted in FIG. 1b, only a single row of detector elements 103a is shown (i.e., a detector row). Usually, a multi-slice detector array such as denoted by reference number 103 comprises a plurality of parallel rows of detector elements 103a such that projection data corresponding to a plurality of quasi-parallel or parallel slices can be acquired simultaneously during a scan. Alternatively, an area detector may be utilized to acquire cone-beam data. The detector elements 103a may completely encircle the patient. FIG. 1b also shows a single X-ray source 102; however, many such X-ray sources may also be positioned around gantry 101.

Operation of X-ray source 102 is governed by a control mechanism 109 of CT system 100. This control mechanism comprises an X-ray controller 110 that provides power and timing signals to one or more X-ray sources 102. A data acquisition system 111 (DAS) belonging to said control mechanism 109 samples analog data from detector elements 103a and converts these data to digital signals for subsequent data processing. An image reconstructor 112 receives the sampled and digitized X-ray data from data acquisition system 111 and performs a high-speed image reconstruction procedure. The image reconstructor 112 may e.g. be specialized hardware residing in computer 113 or a software program executed by this computer. The reconstructed image is then applied as an input to a computer 113, which stores the image in a mass storage device 114. The computer 113 may also receive signals via a user interface or graphical user interface (GUI). Specifically, said computer may receive commands and scanning parameters from an operator console 115 which in some configurations may include a keyboard and mouse (not shown). An associated display 116 (e.g., a cathode ray tube display) allows the operator to observe the reconstructed image and other data from computer 113. The operator-supplied commands and parameters are used by computer 113 to provide control signals and information to X-ray controller 110, data acquisition system 111 and a table motor controller 117 (also referred to as “movement controller”) which controls a motorized patient table 104 so as to position patient 107 in gantry 101. Particularly, patient table 104 moves said patient through gantry opening 105.

In some configurations, computer 113 comprises a storage device 118 (also referred to as “media reader”), for example, a floppy disk drive, CD-ROM drive, DVD drive, magnetic optical disk (MOD) device or any other digital device including a network connecting device such as an Ethernet device for reading instructions and/or data from a computer-readable medium, such as a floppy disk 119, a CD-ROM, a DVD or another digital source such as a network or the Internet. The computer may be programmed to perform functions described herein, and as used herein, the term “computer” is not limited to just those integrated circuits referred to in the art as computers, but broadly refers to computers, processors, microcontrollers, microcomputers, programmable logic controllers, application specific integrated circuits and other programmable circuits.

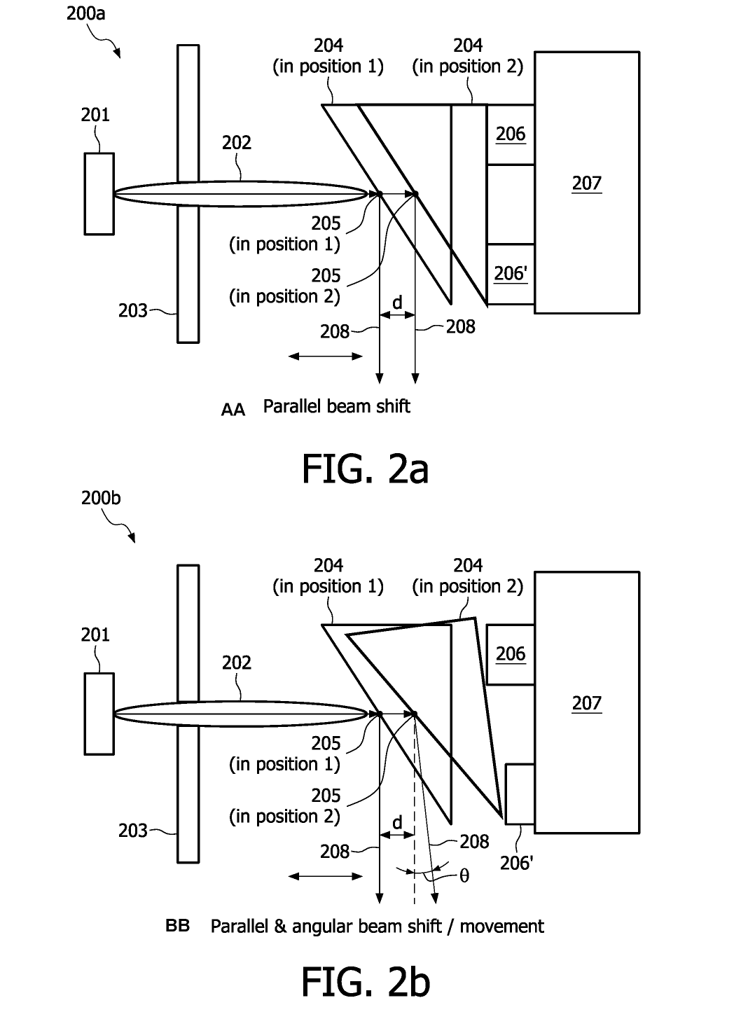

A novel setting 200a for an X-ray source according to a first exemplary embodiment of the present invention with an electron beam emitter 201 of the carbon nanotube (CNT) type which generates an electron beam 202 impinging on the position of a focal spot 205 located on a surface of an X-radiation emitting anode 204 inclined with respect to a plane normal to the direction of the electron beam is shown in FIG. 2a. As can be derived from this figure, said anode can be translationally displaced in the direction of said electron beam by means of two stationarily mounted piezo actuators 206 and 206′. The resultant X-ray beam can thus be shifted in parallel by distance d. As an alternative to this setting, also a single piezo actuator 206 could be used. Synchronously to the piezo control, the focusing has to be aligned to get the same focal spot size on the anode target 204. Therefore, elongation Δl of piezo actuators 206 and 206′ is preferably the same as the desired parallel shift d of the X-ray beam.

A modification of this setting is shown in FIG. 2b, wherein said anode is both translationally displaced in the direction of said electron beam and rotationally displaced by an acute angle θ about the focal spot position 205 by means of two stationarily mounted piezo actuators 206 and 206′ which are individually controlled. Thus, not only a parallel beam shift is possible but also a larger coverage by moving the beam direction.

Both configurations thereby provide a beam movement, which corresponds to a virtual source shift which can advantageously be used to optimize the sampling conditions for achieving an improved spatial resolution.

According to a further refinement of the setup geometry depicted in FIGS. 2a and 2b, further piezo actuators (not shown) which may e.g. be located behind the drawing plane may be foreseen. For example, a novel setting with at least three or four actuators located at the edge positions or in the other corners of anode 204 may be provided. This allows to translationally or rotationally move said anode in at least one further rectilinear or curvilinear direction, e.g. in a translational direction normal to the drawing plane and thus normal to the direction of electron beam 202 or in a rotational direction about an axis of rotation coinciding with the propagation direction of said electron beam, which makes it possible to perform a scan over the complete solid angle Ω=4π (given in steradians, sr) if each actuator is individually controlled.

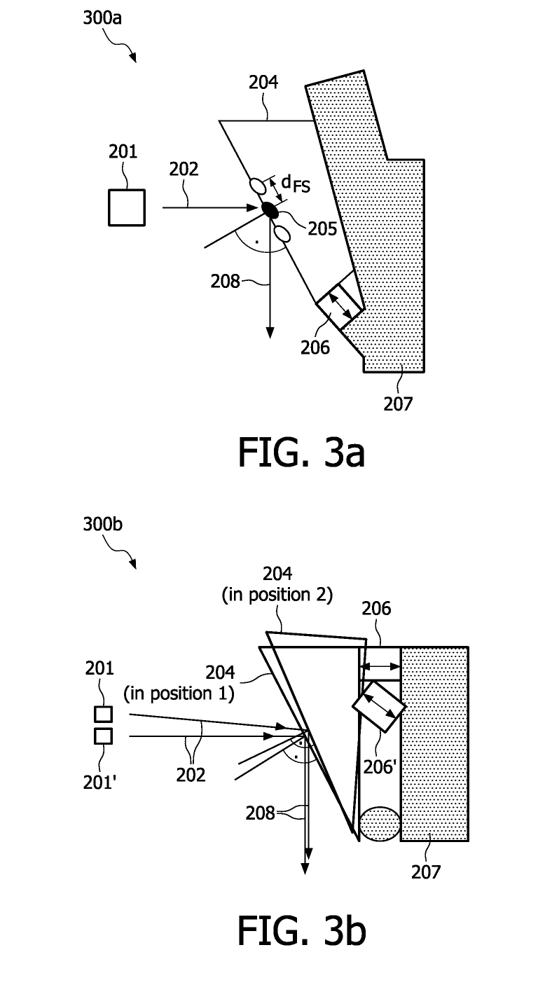

A further novel setting for an X-ray source according to a second exemplary embodiment of the present invention with an electron beam emitter 201 of the CNT type which generates an electron beam 202 impinging on the position of a focal spot 205 located on a surface of an X-radiation emitting anode 204 inclined with respect to a plane normal to the direction of the electron beam is shown in FIG. 3a. As can be taken from this figure, said anode can be translationally displaced in the direction along the inclination angle of its inclined surface by means of a stationarily mounted piezo actuator 206. This could be a one-dimensional or a two-dimensional movement. The distance to be overcome should be at least in the size of the focal spot size but of course a larger movement (such as e.g. a movement of twice the focal spot size or larger) could allow several target points next to each other and the local temperature distribution would be improved for the overall power. Irrespective of the anode geometry of the inclination angle of said anode, it is provided that the movement does not lead to a different X-ray beam direction or geometry.

A modification of this setting is depicted in FIG. 3b, wherein said anode 204 can be both translationally displaced in the direction of said electron beam 202 and rotationally displaced about the focal spot position by means of two stationarily mounted piezo actuators 206 and 206′. Thereby, it is provided that the elongation of the piezo actuators 206 and 206′ is relatively small and that anode 204 is adjusted in a way that the X-ray beam impinging on the inclined anode surface covers always the same field of view. Therefore, it might be necessary to have a second CNT emitter 201′ in a slightly different position (and maybe also means for performing an adapted focusing). The fast switching capability of CNT emitters allows also a multiple emitter placement as long as the “final” output beam of the X-ray source unit always covers the same field of view with more or less identical beam quality. Different settings could be adjusted by means of a calibration procedure.

As already described with reference to the setup geometry depicted in FIGS. 2a and 2b, further piezo actuators (not shown) which may e.g. be located behind the drawing plane may also be foreseen in the setup geometry according to this second exemplary embodiment as depicted in FIGS. 3a and 3b. Again, a novel setting comprising at least three or four actuators located at the edge positions or in the corners of anode 204, which makes it possible to perform a scan over the complete solid angle Ω=490 [sr] if each of these actuators is individually controlled, would be a conceivable design option which may also be realized.

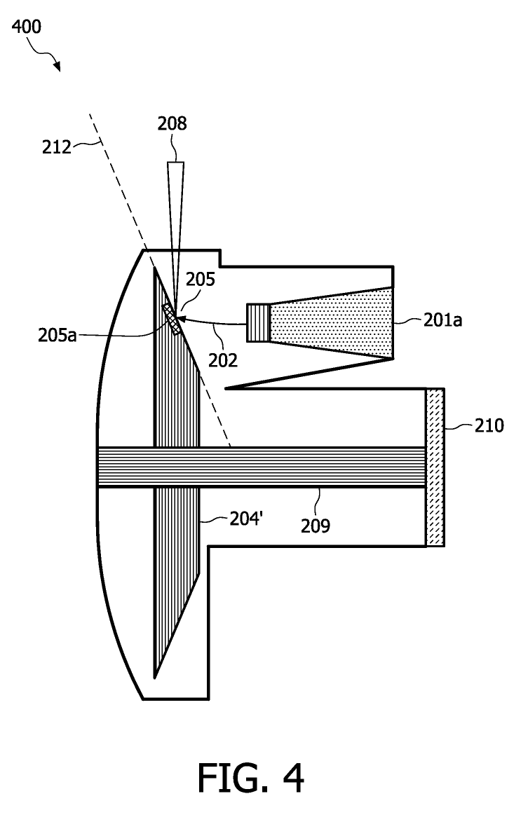

A design cross section (profile) of a conventional rotary anode disk as known from the prior art is shown in FIG. 4. It comprises a rotary anode 204′ with a planar X-radiation emitting surface inclined by an acute angle with respect to a plane normal to the direction of an incoming electron beam 202 impinging on said anode at the position of a focal spot 205 which is mounted on a rotary shaft 209 that rotates said anode about a rotational axis. From FIG. 4 it can be seen that the heat which is generated in the focal spot on the rotating anode is confined to a very narrow toroidal region 205a, which extends to about one centimeter below the inclined anode surface. This may lead to overheating, unless the power rating is limited. The task is now to enlarge the heat storage capacity, which is “immediately” available. Therefore, the volume, which is accessible by the heat, needs to be as large as possible.

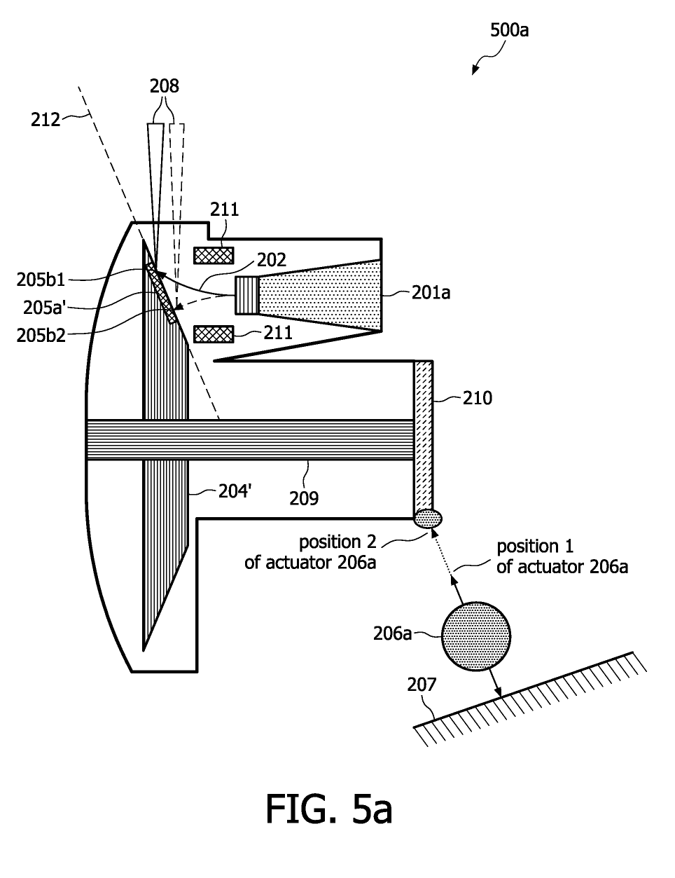

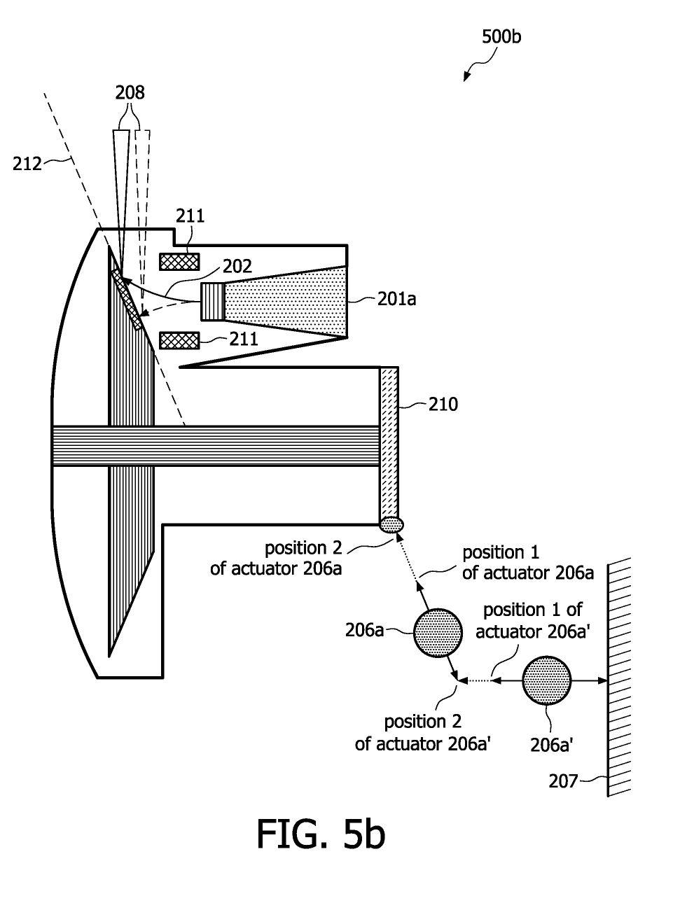

A cross-sectional view of an X-ray tube of the rotary anode type with an X-radiation emitting anode 204′ having a surface inclined with respect to a plane normal to the direction of a cathode's emitted electron beam 202 impinging on the position of a focal spot located on said surface according to an exemplary embodiment of the present invention is shown in FIG. 5a. Thereby, said X-ray tube is equipped with an actuator unit 206a for performing at least one translational displacement movement of said at least one X-ray source's rotary anode 204′ in the direction along the inclination angle of its inclined surface relative to a stationary mounting plate 207 and with a deflection means 211 for generating an electric and/or magnetic field which deflects said electron beam in a direction opposite to the direction of the rotary anode's translational displacement movement. During a CT scan, the electron beam 202 is increasingly deflected outward to enlarge the volume of heat spread of the focal spot track and improve the instantaneously available heat capacity. Using an actuator 206a, the focal spot position is kept constant relative to the mounting plate by moving the X-ray source at the same time along a line of displacement 212 running in the direction along the anode's inclination angle.

A modification of this X-ray tube is depicted in FIG. 5b, which shows the setting described with reference to FIG. 5a comprising a further actuator unit 206a′ for performing at least one translational displacement movement of said at least one X-ray source's rotary anode 204′ in a direction parallel to the anode's rotary shaft 209 relative to said stationary mounting plate 207.

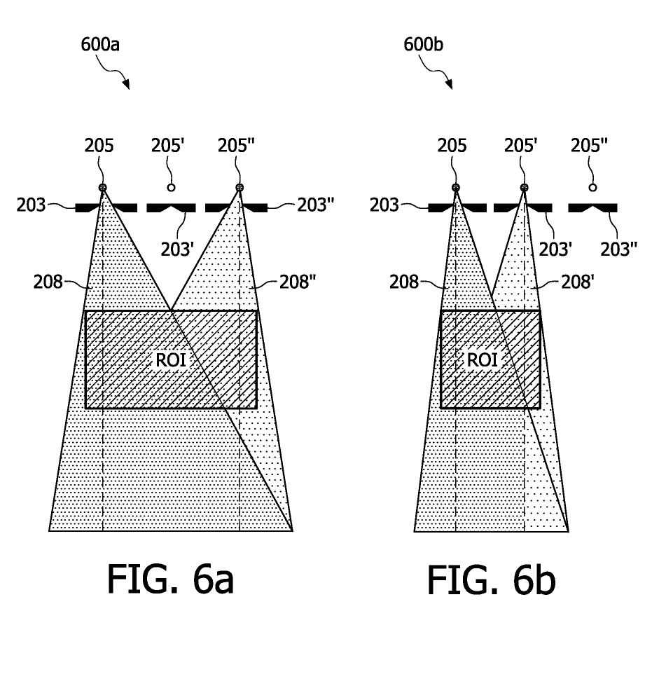

Two schematically depicted application scenarios with two X-ray tubes of the rotary anode type having a variable focal spot distance, which may be needed for performing an axial cone beam CT, are shown in FIGS. 6a and 6b. According to the herein depicted embodiment, actuator means are provided for adjusting the focal spot distance depending on the size of a region of interest (ROI) to be scanned so as to allow dose saving and minimize cone beam artifacts. This ROI may have a length and width between six and eight centimeters in case of brain studies and between 10 and 16 centimeters in case of heart and lung studies, respectively. For this reason, a continuous adjustment is desired. One of solutions may be to adjust and move the X-ray sources mechanically along the axial direction of the rotational shaft 209 with an actuator 206a′ before the scan begins.

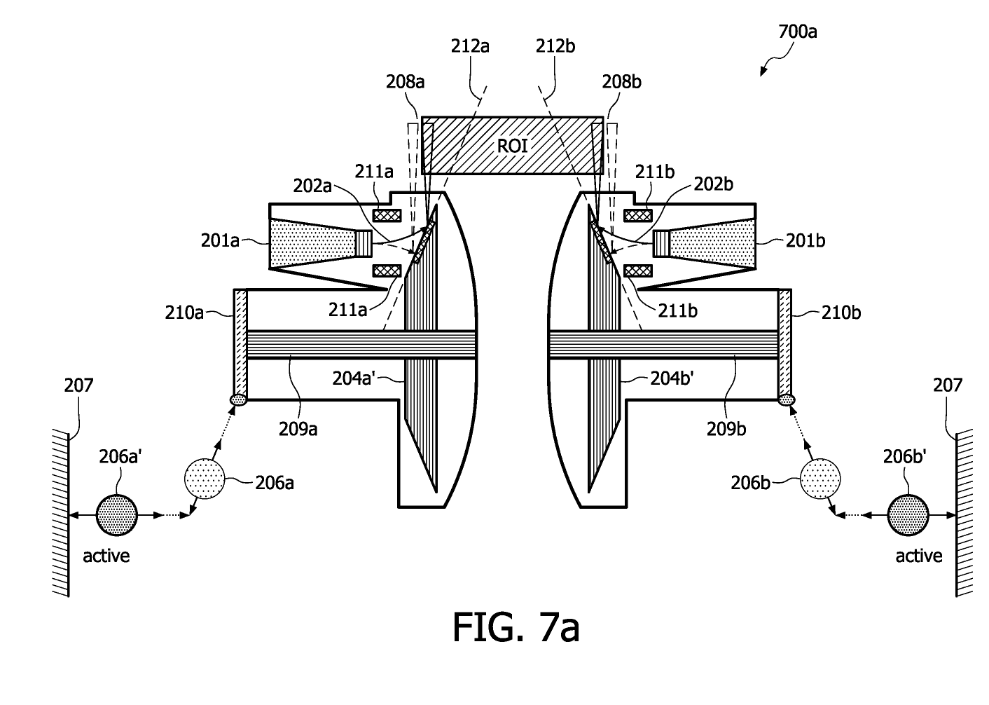

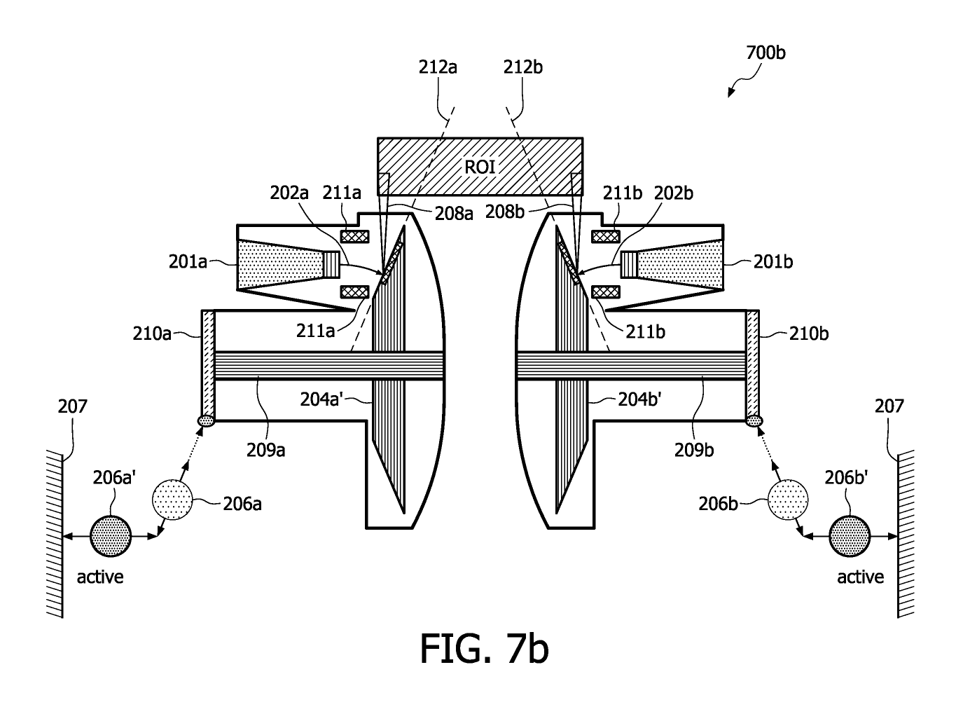

An application scenario with two X-ray tubes of the rotary anode type each having an X-radiation emitting anode 204a′ or 204b′ with a surface inclined with respect to a plane normal to the direction of an electron beam 202a or 202b impinging on the position of a focal spot located on said surface according to an exemplary embodiment of the present invention is depicted in FIG. 7a. A similar application scenario for scanning a wider region of interest is shown in FIG. 7b. As can be seen from these figures, said X-ray tubes are each equipped with two actuator means 206a and 206a′ or 206b and 206b′, respectively, for performing a translational displacement of their focal spots in a direction parallel to the anodes' rotary shafts 209a and 209b relative to at least one stationary mounting plate 207. Furthermore, each X-ray tube is equipped with a deflection means 211a or 211b for generating an electric and/or magnetic field deflecting the electron beams such that the rotary anodes' translational displacement movement is compensated. The tubes may e.g. be mounted on the rotor of a gantry of a CT scanner system to generate two distinct radiation fan beams. According to the herein depicted embodiment, the focal spot distance of up to ca. 20 centimeters is adjustable by a first actuator 206a′ or 206b′, respectively, which moves at least one of the tubes e.g. prior to scanning a patient, depending on the size of a region of interest to be scanned. Additionally, a second (or combined) actuator 206a or 206b, respectively, allows for a shift of said X-ray tubes along a respective one of two individual lines of displacement 212a and 212b along their anode angles during scanning. At least one straight movement of both tubes is provided during the scan, which may take one second up to 20 seconds. In this connection, it should be noted that each line of displacement is the extension of the connection of the particular tube's focal spot with the rotational axis of the respective anode 204a′ or 204b′ along this anode's inclined surface. The position of the focal spot relative to the location of a detector irradiated by the X-ray beam emitted from said anode is kept constant by a coordinated and simultaneous (counter-)deflection of the respective cathode's emitted electron beam.

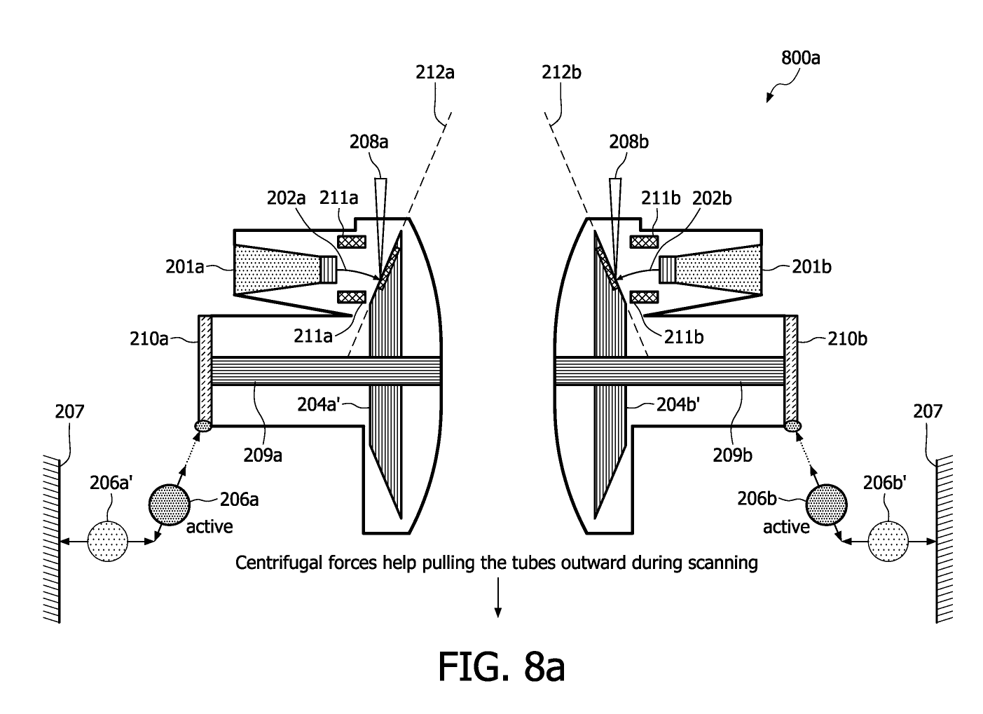

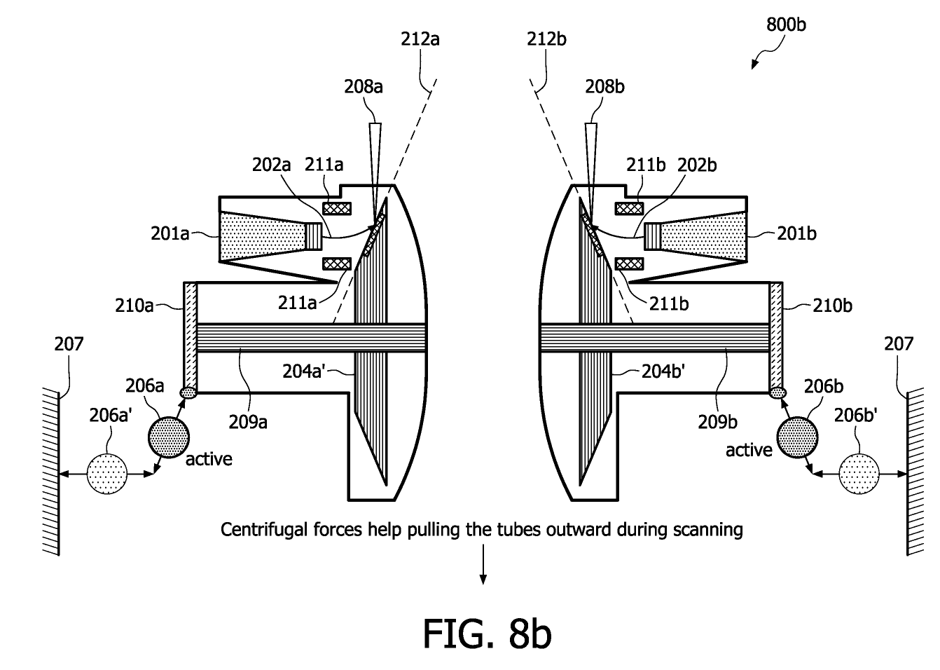

An application scenario with two X-ray tubes of the rotary anode type each having an X-radiation emitting anode 204a′ or 204b′ with a surface inclined with respect to a plane normal to the direction of an electron beam 202a or 202b impinging on the position of a focal spot located on said surface according to an exemplary embodiment of the present invention is depicted in FIG. 8a. Thereby, it is foreseen that the inner part of the focal track is heated. A similar application scenario with the outer part of the focal track being heated is shown in FIG. 8b. As shown, the X-ray tubes are each equipped with two actuator means 206a and 206a′ or 206b and 206b′, respectively, for performing a translational displacement of their focal spots in the direction along the inclination angles of their inclined surfaces relative to at least one stationary mounting plate 207. They are both equipped with a deflection means 211a or 211b for generating an electric and/or magnetic field deflecting the emitted electron beams in an opposite direction such that the rotary anodes' translational displacement movement is compensated.

In a further exemplary embodiment of the present invention, the two X-ray tubes are located in a single vacuum casing which may e.g. consist of two parts connected by a bellows system. In another embodiment of a this “bellows design”, both X-ray tubes share the same cathode and the one of the X-ray tubes which is the most proximal to the shared cathode may have a bladed anode of the windmill-type. This proximal anode is hit by the electron beam, when one of its blades is crossing the beam. Then the distal anode is not active and vice versa. The bellows system thereby allows for an adjustment of the focal spot positions in tangential and radial direction, relative to the rotor of the CT scanner system's rotational gantry.

The benefits of the invention according to the above-described third exemplary embodiment consist in that a combination of X-ray sources for axial large cone beam CT is provided to generate at least two focal spots so as to avoid missing data problems and intrinsic cone beam artifacts. As the scan time may be too short to let the heat travel a considerable distance, the heat loading of the focal spot is greatly reduced by spreading the heat over a larger focal spot track. To achieve this, the X-ray tubes are shifted basically radially on the rotor of the CT system gantry, and the distance of the focal spot position to the detector is kept constant with a proper (counter-) deflection of their electron beams. Thereby, the power rating of the X-ray tubes can be greatly improved. Alternatively or in addition to that, anode materials with reduced thermal stability can be used. As an actuator will be implemented anyway to adjust the focal spot distance, the additional effort is reasonable.

The present invention is thereby based on the precondition of using an actuator for axial adjustment of the focal spot distance of dual focal spot sources for axial cone beam CT, in case a dual tube solution is chosen. The inventive step thereby consists in the fact that actuator means for translational displacements of the X-ray tubes relative to a stationary mounting plate are provided for executing translational displacement movements of the X-ray tubes during a running scanning procedure. Simultaneously, the electron beam impinging on the position of the X-ray tubes' focal spots can be deflected in radial direction. As a result, a reduction of the maximum temperature of the focal spot can be achieved as the area and volume of heat spread and therefore the instantaneously available heat storage capacity beneath the focal spot track is enhanced, which thus serves for obtaining an improved power rating.

### APPLICATIONS OF THE PRESENT INVENTION

The present invention can be applied to any field of X-ray imaging, such as e.g. in the scope of micro-CT, tomosynthesis, X-ray and CT applications, and for any type of X-ray sources, especially for X-ray sources of the rotary anode type, CNT emitter based X-ray sources or X-ray sources which are equipped with any other type of electron beam emitters, such as e.g. small thermal emitters. Although the herein described X-ray scanner apparatus is described as belonging to a medical setting, it is contemplated that the benefits of the invention accrue to non-medical imaging systems such as those systems typically employed in an industrial setting or a transportation setting, such as, for example, but not limited to, a baggage scanning system for an airport or any other kind of transportation center. The invention may especially be employed in those application scenarios where fast acquisition of images with high peak power is required, such as e.g. in the field of X-ray based material inspection or in the field of medical imaging, e.g. in cardiac CT or in other X-ray imaging applications which are applied for acquiring image data of fast moving objects (such as e.g. the myocard) in real-time.

While the present invention has been illustrated and described in detail in the drawings and in the foregoing description, such illustration and description are to be considered illustrative or exemplary and not restrictive, which means that the invention is not limited to the disclosed embodiments. Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. Furthermore, it is to be noted that any reference signs in the claims should not be construed as limiting the scope of the invention.

### TABLE OF USED REFERENCE SIGNS AND THEIR MEANINGS

100 conventional CT imaging system as known from the prior art
101 rotational gantry of the conventional CT imaging system 100
102 X-ray source or tube 102 mounted to the rotational gantry 101
103 X-ray detector array 103 mounted to the rotational gantry 101 diametrically opposite to said X-ray source or tube 102
103a plurality of detector elements 103a said X-ray detector array 103 is equipped with which together sense the projected X-rays passing through an object between X-ray detector array 103 and X-ray source 102, such as e.g. the body of a patient 107 to be examined
104 motorized patient table of the conventional CT imaging system 100 which moves patient 107 through gantry opening 105
105 cylindrical gantry opening 105 of said rotational gantry 101
106 fan or cone beam of X-rays projected from said X-ray source or tube 102 towards the X-ray detector array 103 placed at the opposite side of said rotational gantry 101
107 patient, lying on patient table 104
108 axis of rotation of said rotational gantry 101, typically coinciding with the patient's longitudinal axis
109 control mechanism of conventional CT imaging system 100
110 X-ray controller that provides power and timing signals to said X-ray source 102 or to a plurality of X-ray sources
111 data acquisition system (DAS) belonging to said control mechanism 109 which sample analog data from detector elements 103a and converts the data to digital signals for subsequent processing
112 image reconstructor which receives sampled and digitized X-ray data from data acquisition system 111 and performs high-speed image reconstruction
113 computer or workstation 113 to which image data of reconstructed images are applied as an input
114 mass storage device 114 connected to said computer 113
115 operator console from which said computer receives commands and scanning parameters, e.g. comprising a keyboard and a mouse (not shown)
116 associated display (e.g., a cathode ray tube display) which allows the operator to visualize the reconstructed image data received from computer 113
117 motor controller (also referred to as “movement controller”) which controls motorized patient table 104 so as to position patient 107 within rotational gantry 101
118 storage device (also referred to as “media reader”) such as e.g. a floppy disk drive, CD-ROM drive, DVD drive, magnetic optical disk (MOD) device or any other digital device, such as e.g. a network connecting device (e.g. an Ethernet device), for reading instructions and/or data from a computer-readable medium 119
119 computer-readable medium, such as e.g. a floppy disk, a CD-ROM, a DVD or any other digital source such as a network or the Internet
200a novel setting for an X-ray source according to a first exemplary embodiment of the present invention with an electron beam emitter of the carbon nanotube (CNT) type which generates an electron beam impinging on the position of a focal spot located on a surface of an X-radiation emitting anode inclined with respect to a plane normal to the direction of the electron beam, wherein said anode is translationally displaced in the direction of said electron beam by means of two stationarily mounted piezo actuators
200b modification of the setting as depicted in FIG. 2a, wherein said anode is both translationally displaced in the direction of said electron beam and rotationally displaced about the focal spot position by means of the aforementioned two stationarily mounted piezo actuators
201 electron beam emitting cathode, used for generating electron beam 202
201′ further electron beam emitting cathode, used for generating another electron beam 202
201a electron beam emitting cathode of a first X-ray tube, used for generating electron beam 202a
201b electron beam emitting cathode of a second X-ray tube, used for generating electron beam 202b
202 electron beam, emitted by cathode 201
202a electron beam, emitted by the cathode 201a of said first X-ray tube
202b electron beam, emitted by the cathode 201b of said second X-ray tube
203 focusing unit in a fixed position, used for focusing the electron beam 202 on the position of the focal spot 205 on the X-radiation emitting surface of said X-ray source's anode 204
203′ focusing unit 203, used for focusing a second focal spot
203″ focusing unit 203, used for focusing said second focal spot
204 anode with planar X-radiation emitting surface inclined by an acute angle with respect to a plane normal to the direction of an incoming electron beam 202 impinging on said anode at the position of a focal spot 205
204′ rotary anode with planar X-radiation emitting surface inclined by an acute angle with respect to a plane normal to the direction of an incoming electron beam 202 impinging on said anode at the position of a focal spot 205
204a′ rotary anode of said first X-ray tube with a planar X-radiation emitting surface inclined by an acute angle with respect to a plane normal to the direction of an incoming electron beam 202 impinging on said anode at the position of a focal spot 205
204b′ rotary anode of said second X-ray tube with a planar X-radiation emitting surface inclined by an acute angle with respect to a plane normal to the direction of an incoming electron beam 202 impinging on said anode at the position of a focal spot 205
205 focal spot position on the inclined surface of said anode 204 or 204′
205′ first position of a further focal spot on the inclined surface of said second X-ray tube's anode
205″ second position of said further focal spot on the inclined surface of said second X-ray tube's anode
205a narrow toroidal region, accessible for the electron beam's generated heat during short scan times, which tends to overheat
205a′ large volume for heat spread (large heat capacity, reduced temperature)
205b1 first focal spot position on focal track
205b2 second focal spot position on focal track
206 integrated actuator unit for performing at least one translational and/or rotational displacement movement of the anode 204 relative to at least one stationary electron beam emitting cathode 201 used for generating said electron beam 202
206′ integrated actuator unit for performing at least one translational and/or rotational displacement movement of the anode 204 relative to at least one stationary electron beam emitting cathode 201 used for generating said electron beam 202
206a first integrated actuator unit of a first X-ray tube, given by an electromotor or by a piezo crystal actuator which generates a mechanical stress or strain when an electric field is applied to it
206a′ second integrated actuator unit of said first X-ray tube, given by an electromotor or by a piezo crystal actuator which generates a mechanical stress or strain when an electric field is applied to it
206b first integrated actuator unit of a second X-ray tube, given by an electromotor or by a piezo crystal actuator which generates a mechanical stress or strain when an electric field is applied to it
206b′ second integrated actuator unit of said second X-ray tube, given by an electromotor or by a piezo crystal actuator which generates a mechanical stress or strain when an electric field is applied to it
207 stationary mounting plate
208 X-ray beam, emitted by said anode 204
208a X-ray beam, emitted by anode 204a of said first X-ray tube
208b X-ray beam, emitted by anode 204a of said second X-ray tube
209 rotary anode shaft (rotor) of said X-ray tube
209a rotary anode shaft (rotor) of said first X-ray tube
209b rotary anode shaft (rotor) of said second X-ray tube
210 tube suspension of said X-ray tube
210a tube suspension of said first X-ray tube
210b tube suspension of said second X-ray tube
211 deflection means for generating an electric and/or magnetic field deflecting the electron beam 202 emitted by said cathode 201 in a direction opposite to the direction of the translational displacement movement of anode 204 or 204′
211a deflection means of said first X-ray tube for generating an electric and/or magnetic field deflecting the electron beam 202a emitted by cathode 201a in a direction opposite to the direction of the translational displacement movement of rotary anode 204a′
211b deflection means of said second X-ray tube for generating an electric and/or magnetic field deflecting the electron beam 202b emitted by cathode 201b in a direction opposite to the direction of the translational displacement movement of rotary anode 204b′
212 rectilinear displacement line (also referred to as “line of mechanical displacement”) running in the direction of the inclination angle of anode 204 or 204′
212a rectilinear displacement line (“line of mechanical displacement”) running in the direction of the inclination angle of anode 204a′
212b rectilinear displacement line (“line of mechanical displacement”) running in the direction of the inclination angle of anode 204b′
300a further novel setting for an X-ray source according to a second exemplary embodiment of the present invention with an electron beam emitting cathode 201 of the carbon nanotube (CNT) type which generates an electron beam 202 impinging on the position of a focal spot 205 located on a surface of an X-radiation emitting anode 204 inclined with respect to a plane normal to the direction of the electron beam, wherein said anode is translationally displaced in the direction along the inclination angle of its inclined surface by means of a stationarily mounted piezo actuator 206
300b modification of the setting as depicted in FIG. 3a, wherein said anode 204 is both translationally displaced in the direction of said electron beam 202 and rotationally displaced about the focal spot position by means of two stationarily mounted piezo actuators 206 and 206′
400 design cross section (profile) of a conventional rotary anode disk as known from the prior art
500a cross-sectional view of an X-ray tube of the rotary anode type according to a third exemplary embodiment of the present invention with an X-radiation emitting anode 204′ having a surface inclined with respect to a plane normal to the direction of a cathode's emitted electron beam 202 impinging on the position of a focal spot located on said surface according to an exemplary embodiment of the present invention, said X-ray tube being equipped with an actuator unit 206a for performing at least one translational displacement movement of said at least one X-ray source's rotary anode 204′ in the direction along the inclination angle of its inclined surface relative to a stationary mounting plate 207 and with a deflection means for generating an electric and/or magnetic field deflecting said electron beam in a direction opposite to the direction of the rotary anode's translational displacement movement
500b modification of the X-ray tube depicted in FIG. 5a with a further actuator unit 206a′ for performing at least one translational displacement movement of said at least one X-ray source's rotary anode 204′ in a direction parallel to the anode's rotary shaft 209 relative to said stationary mounting plate 207
600a+b two schematically depicted application scenarios with two X-ray tubes of the rotary anode type having a variable focal spot distance, wherein said focal spot distance is adjusted depending on the size of a region of interest to be scanned
700a application scenario with two X-ray tubes of the rotary anode type each having an X-radiation emitting anode 204a′ or 204b′ with a surface inclined with respect to a plane normal to the direction of an electron beam 202a or 202b impinging on the position of a focal spot located on said surface according to an exemplary embodiment of the present invention, said X-ray tubes each being equipped with two actuator means 206a and 206a′ or 206b and 206b′, respectively, for performing a translational displacement of their focal spots in a direction parallel to the anodes' rotary shafts 209a and 209b relative to at least one stationary mounting plate 207 and each being equipped with a deflection means 211a or 211b for generating an electric and/or magnetic field deflecting the electron beams such that the rotary anodes' translational displacement movement is compensated
700b application scenario identical to application scenario 700a for the case of a wider region of interest
800a application scenario with two X-ray tubes of the rotary anode type each having an X-radiation emitting anode 204a′ or 204b′ with a surface inclined with respect to a plane normal to the direction of an electron beam 202a or 202b impinging on the position of a focal spot located on said surface according to an exemplary embodiment of the present invention for the case of the inner part of the focal track being heated, said X-ray tubes each being equipped with two actuator means 206a and 206a′ or 206b and 206b′, respectively, for performing a translational displacement of their focal spots in the direction along the inclination angles of their inclined surfaces relative to at least one stationary mounting plate 207 and each being equipped with a deflection means 211a or 211b for generating an electric and/or magnetic field deflecting the emitted electron beams in an opposite direction such that the rotary anodes' translational displacement movement is compensated
800b application scenario identical to application scenario 800a for the case of the outer part of the focal track being heated
d length of the translational focal spot displacement in the direction normal to the direction of an electron beam impinging on the position of a focal spot located on the inclined anode surface
d_{FS} length of the translational focal spot displacement in the direction along the inclination angle of the inclined anode surface relative to the at least one stationary mounting plate 207
θ angle of rotational focal spot displacement

1. An X-ray scanner system comprising an array of spatially distributed, sequentially switchable X-ray sources, said X-ray sources being addressed by a programmable switching sequence with a given switching frequency, wherein each X-ray source comprises
an anode with a planar X-radiation emitting surface inclined by an acute angle with respect to a plane normal to the direction of an incoming electron beam impinging on said anode at the position of a focal spot and
at least one integrated actuator unit for performing at least one translational and/or rotational displacement movement of the anode relative to at least one stationary electron beam emitting cathode used for generating said electron beam.

2. The X-ray scanner system according to claim 1,
wherein the at least one integrated actuator unit is given by a piezo crystal actuator which generates a mechanical stress or strain when an electric field is applied to it.

3. The X-ray scanner system according to claim 1, comprising an actuator control unit for controlling the size, direction, speed and/or acceleration of the anode's translational and/or rotational displacement movement performed by the at least one integrated actuator unit dependent on the deviation of the anode temperature at the focal spot position from a nominal operation temperature.

4. The X-ray scanner system according to claim 1, wherein said actuator control unit is adapted for controlling the size, direction, speed and/or acceleration of the anode's translational and/or rotational displacement movement performed by the at least one integrated actuator unit dependent on the switching frequency for sequentially switching said X-ray sources such that an image acquisition procedure executed by means of said X-ray scanner system yields a set of 2D projection images which allows an exact 3D reconstruction of an image volume of interest without blurring or temporal aliasing artifacts.

5. The X-ray scanner system according to claim 1, wherein each X-ray source comprises
at least one focusing unit for focusing the electron beam on the position of the focal spot on the X-radiation emitting surface of said X-ray source's anode and
a focusing control unit for adjusting the focusing of the anode's focal spot such that deviations in the focal spot size resulting from the translational and/or rotational displacement of the anode relative to the at least one stationary electron beam emitting cathode are compensated.

6. The X-ray scanner system according to claim 1, wherein the anode's translational displacement movement goes along a rectilinear displacement line in the direction of the anode's inclination angle.

7. The X-ray scanner system according to claim 1, wherein
said actuator control unit is adapted to control said at least one integrated actuator unit such that the X-ray beam emitted by the anode leads to the same X-ray beam direction and thus to the same field of view irrespective of the anode's inclination angle and irrespective of said displacement movement.

8. The X-ray scanner system according to claim 1, wherein the size of the anode's translational and/or rotational displacement movement is in the range of the focal spot size or larger.

9. The X-ray scanner system according to claim 1 wherein the spatially distributed X-ray sources are given by a number of individually addressable X-ray microsources using field emission cathodes in the form of carbon nanotubes.

10. The X-ray scanner system according to claim 1,
wherein said at least one stationary electron beam emitting cathode is realized in carbon nanotube technology.

11. An X-ray scanner system comprising at least one X-ray source of the rotary anode type with an essentially disk-shaped rotary anode, wherein the rotary anode of the at least one X-ray source has a planar X-radiation emitting surface inclined by an acute angle with respect to a plane normal to the direction of an incoming electron beam impinging on said anode at the position of a focal spot, said X-ray scanner system comprising
at least one integrated actuator unit for performing at least one translational displacement movement of said at least one X-ray source's rotary anode relative to a stationary mounting plate.
an actuator control unit for controlling the size, direction, speed and/or acceleration of the rotary anode's translational displacement movement performed by the at least one integrated actuator unit dependent on the deviation of the anode temperature at the focal spot position from a nominal operation temperature,
at least one deflection means for generating an electric and/or magnetic field deflecting the electron beam in a direction opposite to the direction of the rotary anode's translational displacement movement and
a deflection control unit for adjusting the strength of the electric and/or magnetic field such that deviations in the focal spot position resulting from the translational displacement of the rotary anode relative to the stationary mounting plate are compensated.

12. The X-ray scanner system according to claim 11, wherein the at least one integrated actuator unit is given by an electromotor or by a piezo crystal actuator which generates a mechanical stress or strain when an electric field is applied to it.

13. The X-ray scanner system according to claim 11, wherein the anode's translational displacement movement goes along a rectilinear displacement line in the direction of the anode's inclination angle.

14. An X-ray scanner system comprising two or more X-ray sources of the rotary anode type with each X-ray source having an essentially disk-shaped rotary anode, wherein each of these rotary anodes has a planar X-radiation emitting surface inclined by an acute angle with respect to a plane normal to the direction of an incoming electron beam impinging on the respective anode at the position of a focal spot, said X-ray scanner system comprising
at least one integrated actuator unit for performing at least one translational displacement movement by moving each X-ray source relative to a stationary mounting plate,
at least one further integrated actuator unit for performing at least one translational displacement movement in the positions of the two or more X-ray sources' focal spots relative to each other,
at least one deflection means for generating an electric and/or magnetic field deflecting the electron beam in a direction opposite to the direction of the rotary anode's translational displacement movement and
a deflection control unit for adjusting the strength of the electric and/or magnetic field such that deviations in the focal spot position of the respective X-ray source relative to an X-ray detector irradiated by the X-radiation emitted from said X-ray source's rotary anode, said deviations resulting from the translational displacement of the rotary anode relative to the stationary mounting plate, are compensated.

15. The X-ray scanner system according to claim 14, comprising an actuator control unit for controlling the size, direction, speed and/or acceleration of the respective anode's translational displacement movement performed by the at least one integrated actuator unit dependent on the deviation of the anode temperature at the focal spot position from a nominal operation temperature.

16. The X-ray scanner system according to claim 14, wherein said actuator control unit is adapted for controlling the size and/or direction of the translational displacement movement in the positions of the two or more X-ray sources' focal spots relative to each other depending on the size of a region of interest to be scanned.

17. The X-ray scanner system according to claim 14, wherein the anode's translational displacement movement goes along a rectilinear displacement line in the direction of the anode's inclination angle.

18. The X-ray scanner system according to claim 14, wherein the translational displacement movement for adjusting the focal spot positions of the particular X-ray sources with respect to each other goes along a rectilinear displacement line in axial and/or radial direction relative to the rotor of a rotational gantry said X-ray scanner system is equipped with.

19. The X-ray scanner system according to claim 14, wherein said X-ray sources are located in a single vacuum casing consisting of two parts connected by a bellows systems which allows for an adjustment of the focal spot positions in tangential and radial direction relative to the rotor of the rotational gantry.

20. The X-ray scanner system according to claim 14, wherein the X-ray source which is the most proximal with respect to a common electron beam emitting cathode shared by these X-ray sources has a bladed anode of the windmill type.
